(19) United States
(12) Patent Application Publication
(10) Pub. No.: US 2022/0343744 A1
(43) Pub. Date: Oct. 27, 2022

(54) WEARABLE HAZARD WARNING SYSTEM FOR PEDESTRIANS

(71) Applicants: Joshua D. Isenberg, Fremont, CA (US); Bing L. Isenberg, Fremont, CA (US)

(72) Inventors: Joshua D. Isenberg, Fremont, CA (US); Bing L. Isenberg, Fremont, CA (US)

(21) Appl. No.: 17/725,881

(22) Filed: Apr. 21, 2022

Related U.S. Application Data
(60) Provisional application No. 63/178,713, filed on Apr. 23, 2021.

(51) Int. Cl. G08B 21/02

(52) U.S. Cl. CPC G08B 21/02; G08B 7/06

(57) ABSTRACT

A pedestrian hazard warning system includes a sensor device configured to sense a signal reflected from objects at ground-level and generate a corresponding output; hazard determination logic configured to analyze the output from the sensor device and determine therefrom an abrupt change in ground-level conditions that corresponds to the presence of a hazard; and a wearable warning mechanism interoperable with the hazard determination logic and configured to trigger in a pedestrian an instinctive response that draws the pedestrian's attention towards the hazard. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This applications claims the priority benefit of U.S. Provisional Patent Application No. 63/178,713, filed Apr. 23, 2021, the entire contents of which are incorporated herein by reference.

### FIELD OF THE DISCLOSURE

Aspects of the present disclosure are related to hazard warning systems and more particularly to wearable hazard warning systems.

### BACKGROUND OF THE INVENTION

Accidents involving falls are estimated to account for 15 percent of all accidental deaths in the United States. Only motor vehicle accidents are more common. Slip and fall accidents can occur in the workplace, in the home, or anywhere else. Such accidents can be quite serious. For example, in 2016, 697 workers died in fall-related accidents and more than 33,000 people died from falls in 2015. In 2016 48,060 were injured severely enough during a fall to require days off work and 9.2 million people required emergency room treatment from fall-related injuries. Each year, over 8 million emergency room visits are due to slips, trips, and falls. Between 20 percent and 30 percent of people experience an injury after falling. Such injuries include lacerations, hip fractures, or head traumas.

The National Safety Council's Odds of Dying list ranks falls as the 6th most likely cause of death, with the odds of dying from all causes is estimated at 1 in 127. It is estimated that 50 percent of all accidental deaths occurring in the home are due to falls. Falls are the most common cause of traumatic brain injuries. Furthermore, falls are the leading cause of death for adults 65 and older.

Most methods to avoid trip hazards involve making them more visible, e.g., yellow paint on steps or curbs, “caution” signs, warning lights. These efforts, though certainly helpful rely on pedestrians paying attention to their surroundings. Pedestrians, however, are often distracted and are often oblivious to hazards that could cause a slip or trip and fall.

U.S. Pat. Nos. 10,685,246, 10,303,958, 9,916,509, and 9,443,163 describe systems and methods for curb detection and pedestrian hazard assessment. These patents all relate to systems that warn autonomous vehicles of the presence of pedestrians. For example, U.S. Pat. No. 10,685,246 describes a detection system having an image capture device that acquires of images of an area forward of the vehicle that includes a curb separating a road surface from an off-road surface and a data interface. A processing device is programmed to receive the images via the data interface and determine a plurality of curb edge line candidates in the images and identify at least one edge line candidate as an edge line of the curb.

U.S. Pat. No. 10,773,643 describes a method and device for providing advanced pedestrian assistance system to protect pedestrian preoccupied with smartphone. The smartphone instructs a locating unit to acquire 1st information including location and velocity information of the pedestrian and location and velocity information of the smartphone. A detecting unit is instructed to acquire 2nd information including hazard statuses of hazardous areas near the pedestrian and location information and velocity information of hazardous objects, by referring to the 1st information and images acquired by phone cameras linked with the smartphone. A control unit calculates a degree of safety of the pedestrian by referring to the 1st and 2nd information and transmits a hazard alert to the pedestrian via the smartphone. Such a system presupposes that the pedestrian is equipped with a smartphone, that the smartphone can communicate with the detecting unit and that the warning will be timely and relevant. None of these things is guaranteed.

U.S. Pat. No. 10,231,664 describes a method and apparatus to predict, report, and prevent episodes of emotional and physical responses to physiological and environmental conditions. The described system uses a wearable device to detect physiological stress in a patient, administer a corresponding therapeutic response and notify a caregiver.

It is within this context that aspects of the present disclosure arise.

### BRIEF DESCRIPTION OF THE DRAWINGS

Aspects of the present disclosure can be readily understood by considering the following detailed description in conjunction with the accompanying drawings, in which:

FIG. 1 is a block diagram of a pedestrian hazard warning system according to an aspect of the present disclosure.

FIG. 2 is a flow diagram of a method of operating the system of FIG. 1.

FIG. 3 is a block diagram of a hazard warning system according to an aspect of the present disclosure.

FIG. 4A is a schematic diagram of a pedestrian hazard warning system incorporated into an article of footwear according to aspects of the present disclosure.

FIG. 4B is a schematic diagram of an alternative pedestrian hazard warning system incorporated into a ring according to aspects of the present disclosure.

FIG. 4C is a schematic diagram of an alternative pedestrian hazard warning system incorporated into an article of eyewear according to aspects of the present disclosure.

FIG. 5 is a timing diagram illustrating detection of hazards with a pedestrian hazard warning system incorporated into an article of footwear according to aspects of the present disclosure.

FIGS. 6A-6D are schematic diagrams illustrating examples of determining a position and orientation of an encoded pattern from an image of the encoded pattern.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In the following Detailed Description, reference is made to the accompanying drawings, which form a part hereof, and in which is shown by way of illustration specific embodiments in which the invention may be practiced. In this regard, directional terminology such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Introduction

Aspects of the present disclosure are based on certain premises. The first premise is that the pedestrian hazard warning system should detect and warn of environmental conditions that could lead to a fall with high reliability. The second premise is that the system desirably detects hazards under a variety of conditions. The third premise is that the system draws the user's attention to a detected hazardous condition in a manner that is (a) timely and (b) effective. A fourth premise is that the system is desirably not dependent on other electronic devices such as a cellular telephone, though it may interoperate with such devices when advantageous to do so. A fifth premise is that the system is desirably unobtrusive.

Since a significant number of falls occur at ground level the system should be able to detect hazardous ground level conditions. Such conditions include, but are not limited to a curb, a step up, a step down or other obstacle that could cause a trip and fall, or a slippery ground surface that could cause a slip and fall. Many of these hazards can be characterized as an abrupt change in ground-level conditions. It is desirable that the system reliably detect such changes.

To timely draw the pedestrian's attention to a detected hazard, the process of obtaining a sensor signal and determining the presence of a hazard should be completed in time to provide sufficient advance warning to give the pedestrian a chance to react.

To effectively draw the pedestrian's attention to a detected hazard, the warning should be configured in a way that triggers in the pedestrian an instinctive response that draws attention towards the hazard.

To be independent of other electronic devices, the system desirably includes its own sensor device, hazard determination logic, and warning mechanism.

To be unobtrusive, the system should include one or more wearable components.

With the aforementioned premises in mind, a pedestrian hazard warning system desirably includes the following components:

A sensor device configured to sense a signal reflected from objects at ground-level and generate a corresponding output; hazard determination logic configured to analyze the output from the sensor device and determine therefrom an abrupt change in ground-level conditions that correspond to a hazard; and a wearable warning mechanism configured to trigger in a pedestrian an instinctive response that draws the pedestrian's attention towards the hazard.

Detailed Discussion

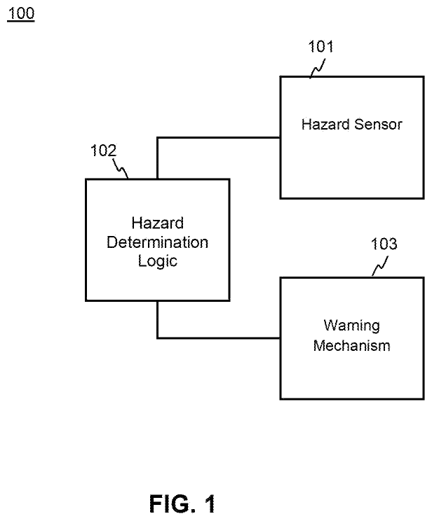

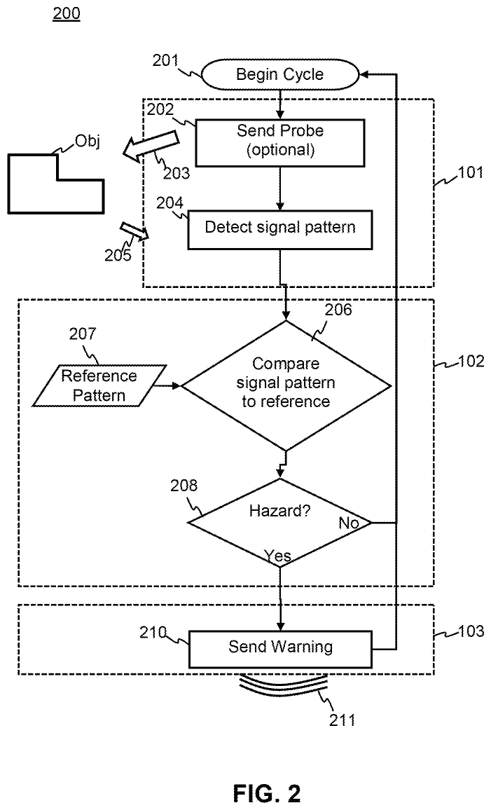

Aspects of the present disclosure may appreciated by referring to FIG. 1 and FIG. 2. FIG. 1 depicts an example of a pedestrian hazard warning system 100 according to aspects of the present disclosure in the form of a block diagram. FIG. 2 illustrates a pedestrian hazard warning 200 that may be implemented with the system 100. The system 100 generally includes a hazard sensor 101, a hazard determination logic element 102, and a warning mechanism 103. These three components may communicate with each other by suitable means. Although illustrated as separate components for the sake of discussion, two or more these three components may be integrated together into a single device. For example, in some implementations it may be convenient to integrate the sensor and warning mechanism into a single device, while the hazard determination logic is part of a different device that can communicate with the sensor and warning mechanism. It is further noted that while a single sensor, logic element and warning mechanism are illustrated, aspects of the present disclosure are not limited to such implementations. Aspects of the present disclosure encompass implementations in which the pedestrian hazard warning system 100 includes one or more hazard sensors 101, one or more hazard determination logic elements 102 and one or more warning mechanisms 103.

Referring to FIG. 2, the system 100 may operate in a cycle that begins as indicated at 201. As noted above, the hazard sensor 101 may be configured to sense a signal from objects at ground-level as indicated at 204 and generate a corresponding output. As used herein, the term “at ground-level” includes distances from surface, e.g., pavement, level up to about head height. The hazard sensor may be placed in different locations depending on the hazard of concern. By way of example, and not by way of limitation, the sensor may be secured to an article of clothing worn on a pedestrian's foot, e.g., a shoe, slipper, sandal, sock, or even a toe ring. In such an implementation, the sensor 101 may generally face forward when worn to sense ground conditions ahead of the pedestrian to detect tripping and slipping hazards. The sensor may use optical, infrared, electromagnetic, ultrasonic or other forms of sensing.

The sensor 101 may include a passive component that receives a probe signal reflected from or emitted by ground-level objects in the pedestrian's environment. The probe signal may be supplied by the environment, e.g., in the form of natural or artificial lighting, sound, temperature, or atmospheric conditions. In some implementations, the sensor 101 may further include a probe signal source that projects a probe signal 203 as indicated at 202. The probe signal 203 may be projected generally forward of the pedestrian and mostly in a narrow cone. When a probe signal 203 is used, the passive component of the sensor may be configured to detect reflections 205 of probe signal from an object Obj within the cone of the projected signal. By way of example, and not by way of limitation, in the case of a tripping hazard detection device, the probe source may be configured to be worn on the shoe, sock, or foot and the probe signal is projected in a cone near to the ground.

By way of example, and not by way of limitation, the probe signal 203 may be any of the following:

1) An optical signal, e.g., infrared (IR), visible, or ultraviolet (UV) radiation, from a suitable source such as a light emitting diode or laser diode. If the device has no integral optical probe signal source an optical probe signal may come from the environment, e.g., in the form of naturally occurring IR, visible, or UV radiation, e.g., from sunlight, moonlight, or starlight or from artificial but incidentally occurring IR, visible, or UV radiation, e.g., from streetlights, building lighting or other sources of artificial light.

2) An electromagnetic signal, e.g., radiofrequency, microwave or terahertz radiation from a suitable source, such as a patch RFID emitter (radiofrequency) or Gunn diode (microwave radiation) or photoconductive terahertz emitter (terahertz radiation). If the device has no integral electromagnetic probe signal source an electromagnetic probe signal may come from the environment, e.g., in the form of naturally occurring electromagnetic signals, e.g., in the form of natural magnetic or electric fields or from artificial but incidentally occurring sources of electromagnetic signals.

3) An acoustic signal, e.g., ultrasound of frequency 20 kilohertz to several gigahertz generated by a suitable source, e.g., a piezoelectric micromachined ultrasound transducer (PMUT) or capacitive micromachined ultrasound transducer (CMUT). If the device has no integral acoustic probe signal source an electromagnetic probe signal may come from the environment, e.g., in the form of naturally occurring acoustic signals, e.g., in the form of natural environmental sounds or from artificial but incidentally occurring sources of sounds.

The sensor 101 is generally configured to receive the reflected or emitted probe signal and generate a corresponding analog or digital electrical signal that can be analyzed by the hazard determination logic element 102. The nature of the sensor 101 depends on the nature of the emitted or reflected probe signal. For example:

1) An optical signal, e.g., infrared, visible, or ultraviolet radiation, may be detected with a suitable detector e.g., a photodiode, photoresistor, charge-coupled device (CCD) or array of such devices.

2) An electromagnetic signal, e.g., radiofrequency, microwave or terahertz radiation, may be detected with a suitably configured antenna and detection electronics.

3) An ultrasound signal, e.g., sound of frequency 20 kilohertz to several gigahertz, may be detected by a suitable ultrasound transducer, e.g., a piezoelectric micromachined ultrasound transducer (PMUT) or capacitive micromachined ultrasound transducer (CMUT). In some implementations, the same ultrasound transducer may be used for both transmitting the projected signal and detecting the reflected signal.

In implementations that include a probe signal source, it is often convenient for the probe signal source and reflected signal detector to be located relatively close to each other and in more or less fixed positions and orientations with respect to each other. In some implementations the source and detector may be part of the same integrated circuit chip or separate chips on the same circuit board or package.

Of course, the system could use two or more different types of detection device each of which may be optimized for detecting hazards at different distances and under different conditions. For example, an acoustic system might work better and detecting hazards at distances out to 5 meters but may have problems detecting hazards at distances less than one meter away. Such a detector could be augmented with an optical detection device.

The hazard determination logic element 102 is generally configured to analyze the output from the sensor device and determine therefrom an abrupt change in ground-level conditions that corresponds to the presence of a hazard. Such logic may be implemented in hardware, e.g., on an application specific integrated circuit (ASIC), in software executed on a general purpose processor that becomes a specific purpose processor when executing such software, in firmware executed on a specific purpose processor or in some combination of two or more of these.

The hazard detection logic 102 communicates with the sensor 101 and may communicate with the probe signal source (if one is part of the system 100). The sensor or hazard determination logic may perform some signal processing on the raw output of the detector to provide a detector signal suitable for the detection logic. Such signal processing may include, but is not limited to, e.g., amplification, attenuation, analog to digital (A/D) conversion, noise rejection, filtering, or windowing. The hazard detection logic analyzes the detector signal over some window of time to determine the presence of a hazard. The relevant window of time may be correlated to movement of the wearer. For example, suppose a device is worn on each foot. As the wearer walks, each foot alternately makes contact with the ground for a short period of time. For such an implementation, the relevant window of time may be a portion of the time that a foot is in contact with the ground.

As indicated at 206 in FIG. 2, the main concept behind hazard determination is to compare a pattern of the analog or digital signal from the sensor 101 over a relevant window of time to some reference pattern 207. Depending on the nature of the comparison, a hazard may be present if the patterns are sufficiently similar or sufficiently different. For example, in some implementations the hazard detection logic may compare the detector signal pattern to one or more stored reference patterns that correspond to known types of hazard such as a step up or a step down.

Alternatively, the hazard determination logic element 102 may compare a detector signal pattern for a current time step to a detector signal pattern for a previous time step. A sufficient difference between the two patterns may indicate the presence of a hazard.

In some implementations, the signal pattern may be in the form of an image represented by a set of one or more pixel values at one or more pixel locations within the image. For example, each pixel may have an associated intensity value and one or more color values. The pixel values in the image may be compared to pixel values for a reference image using known techniques, such as sum of absolute difference (SAD) or sum of absolute transformed distances (SATD), which provide a simple measure of similarity between images or portions thereof. Such measures may be compared to some threshold value to determine the presence of a hazard.

In digital image processing, the sum of absolute differences (SAD) is a measure of the similarity between image blocks. It is calculated by taking the absolute difference between each pixel in the original block and the corresponding pixel in the block being used for comparison. These differences are summed to create a simple metric of block similarity, the L1 norm of the difference image or Manhattan distance between two image blocks. SAD has the advantage of being quick to calculate and is easily parallelizable. The sum of absolute differences provides a simple way to automate the searching for objects inside an image, but may be unreliable due to the effects of contextual factors such as changes in lighting, color, viewing direction, size, or shape. The SAD may be used in conjunction with other object recognition methods, such as edge detection, to improve the reliability of results.

The sum of absolute transformed differences (SATD) is a block matching criterion widely used in fractional motion estimation for video compression. It works by taking a frequency transform, usually a Hadamard transform, of the differences between the pixels in the original block and the corresponding pixels in the block being used for comparison.

In some implementations, the logic element 102 may use changes in signal patterns to detect a hazard in other ways. For example, a change in signal pattern may correspond to a change in the nature of the ground surface in ways that correspond to an imminent hazard. Specifically, an abrupt increase in reflectivity may indicate the presence of a slippery surface or a liquid.

In systems that have two or more types of hazard detection devices, the hazard determination logic element 102 may combine input signals from these different devices to determine the presence of a hazard.

Furthermore, the system 100 may include other types of sensors that provide other information relevant to trip hazard prevention. For example, the hazard detection logic may receive input signals from one or more pressure sensors that sense the pressure of the wearer's feet on the ground on shoes. In particular pressure sensors located under the sole and ball of each foot may be coupled to the hazard detection logic. In some implementations the other sensors may include one or more accelerometers that can sense acceleration with respect to one or more axes. In some implementations, the other sensors may include a location sensing device, e.g., a global positioning satellite (GPS) receiver. Signals from these sensors can provide important information regarding a pedestrian's location, gait or length of stride. Time series signals from such sensors can be analyzed to determine whether the pedestrian is walking normally, running, or taking action to avoid a hazard. Furthermore, a characteristic change in signal value upon placing a foot in contact with the ground can trigger a measurement cycle of the hazard detection device and analysis of the resulting signals by the hazard detection logic. Location sensing information can be useful for storing the locations detected hazards and for facilitating detection of known hazards at known locations.

In some implementations, the logic 102 may include some form of artificial intelligence (AI), such as a neural network that allows the logic to “learn” from a combination of pressure sensor information warning mechanism output and information from the sensor 101 when the pedestrian is paying attention to ground-level conditions. By way of example, the logic 102 may be coupled to a memory that stores histories of sensor signals, warning outputs, and pressure sensor signals. The logic could identify repeated instances in which hazards are detected and a pattern pressure sensor signals abruptly changes prior to a warning being sent. The logic could be trained to recognize a pattern of such instances as an indication that the pedestrian is paying attention to ground-level conditions. Similarly, the logic could identify repeated instances in which hazards are detected and a pattern pressure sensor signals does not change prior to a warning being sent. The logic could be trained to recognize a pattern of such instances as an indication that the pedestrian is not paying attention to ground-level conditions.

As generally indicated at 208 in FIG. 2, if the result of the comparison at 206 is that no hazard is present, a new cycle may begin again at 201. If, however, a hazard is determined to be present, the hazard determination logic 102 triggers the warning mechanism 103 to send a warning, as indicated at 210. The warning mechanism 103 may be a wearable device configured to trigger in a pedestrian an instinctive response that draws the pedestrian's attention towards the hazard in response to determination of the presence of the hazard by the logic element 102. The warning mechanism may produce an audible, visible, tactile or olfactory signal.

The warning is desirably configured to draw the wearer's attention to the general direction of the hazard in sufficient time for the wearer to A) recognize the hazard and B) take action to avoid the hazard. It is desirable that the system is sensitive enough to detect significant hazards with high reliability but not so sensitive that it constantly warns the wearer of insignificant hazards to the point that the wearer ignores the warnings. To this end, the sensor 101 and/or hazard determination logic 102 may apply filters to a raw sensor pattern to produce a filtered sensor pattern that is then analyzed to determine the presence of absence of a pedestrian hazard. Such filters may attenuate selected portions of the signal pattern. Such filters may selectively attenuate one or more portions of the time domain, frequency domain, or spatial domain of the signal pattern so that portions of the signal pattern that correspond to pedestrian hazards stand out from other portions that do not.

According to aspects of the present disclosure, the warning may be configured to draw attention but not alarm, frighten, or startle the wearer. For example, a tactile warning is preferably above the threshold of human sensation but below the threshold of pain. To provide such a warning, the mechanism 103 may include a vibrating element, e.g., a piezoelectric oscillator, and driving circuit configured to cause the vibrating element to vibrate in response to a trigger from the hazard determination logic 102. The amplitude and frequency of a driving signal that causes the vibration may be tuned to appropriately configure the warning.

By way of example, and not by way of limitation, the warning mechanism may include a mechanically oscillating component configured to provide a tactile warning to the wearer. In such an implementation, the warning mechanism may be configured to be worn on a relevant part of the user's body or on clothing normally worn on such a body part.

By way of alternative non-limiting example, the warning mechanism 103 may be configured to optically illuminate a hazard. In such implementations, the warning mechanism may include an illumination source such as a light-emitting diode (LED) or laser configured to direct illumination in the general direction of the hazard. Such illumination may be in the form of radiation in a visible or non-visible portion of the electromagnetic spectrum. For example, non-visible UV radiation could illuminate an area containing fluorescent materials that emit visible radiation when illuminated by UV radiation.

According to non-limiting examples of different configurations, the warning mechanism may be incorporated into:
a shoe, boot, slipper, sandal, sock or stocking that can be worn on a foot or leg;
a glove that can be worn on a hand;
a legging or pant leg that can be worn on a leg;
a ring that can be worn on a digit, such as a finger or toe;
a buckle, such as for a belt or shoe;
a pair of eyeglasses worn on the face;
a hat that can be worn on the head;
a bracelet that can be worn on a wrist or ankle.

According to aspects of the present disclosure, different components of the system may be incorporated into different articles of clothing. For example, the sensor 101 may be incorporated into a different article than the logic 102 or warning mechanism 103.

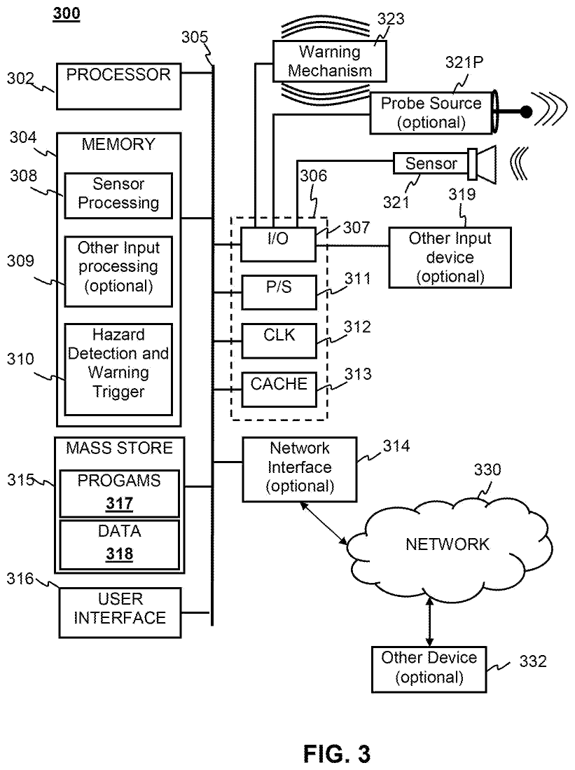

FIG. 3 depicts the system 300 configured carry out the pedestrian warning method described above with respect to FIG. 2. The system 300 generally includes a sensor 321 and warning mechanism 323. These may be configured as discussed above in conjunction with FIG. 1 and FIG. 2. In some implementations, the system 300 may include a probe source 321P. As discussed above, the probe source may emit a probe signal that the sensor can detect after the probe signal reflects from ground-level objects.

To implement the functions of the hazard determination logic 102 discussed above, the system may further include one or more processor units 302, which may be configured according to well-known architectures, such as, e.g., single-core, dual-core, quad-core, multi-core, processor-coprocessor, cell processor, and the like. The system 300 may also include one or more memory units 304 (e.g., random access memory (RAM), dynamic random-access memory (DRAM), read-only memory (ROM), and the like).

The processor unit 302 may implement the hazard determination logic by executing one or more programs 317, portions of which may be stored in the memory 304. Examples of such programs include, but are not limited to, sensor processing 308, other input processing 309 (optional) and a hazard detection and warning trigger routine 310. By way of example, the sensor processing 308 may include filtering of raw sensor output to reject noise and emphasize signal components of interest in a signal pattern from the sensor 321. Furthermore, if a probe source 321P is used, the sensor processing 308 may control timing of probe signal transmission by the probe source and detection by the sensor.

The processor 302 may be operatively coupled to the memory 304, e.g., by accessing the memory via a data bus 305. The programs 317 may be configured provide information to carry out the pedestrian hazard detection and warning as described above in conjunction with FIG. 1 and FIG. 2. Additionally, the Memory 304 may contain information necessary to determine hazards from patterns of signals obtained from the sensor 321. By way of example, and not by way of limitation, such information may include reference patterns corresponding to known hazards. The reference pattern information may also be stored as data 318, e.g., in a mass storage device 315.

The system 300 may also include well-known support circuits, such as input/output (I/O) 307, circuits, power supplies (P/S) 311, a clock (CLK) 312, and cache 313, which may communicate with other components of the system, e.g., via the bus 305. The computing device may include a network interface 314 facilitate communication with other devices 332 via a network 330. The processor unit 303 and network interface 314 may be configured to implement a local area network (LAN) or a personal area network (PAN) via a suitable network protocol, e.g., Ethernet fora LAN or Bluetooth for a PAN. Such a capability is useful for facilitating interaction between the system 300 and common electronic devices such as smartphones, tablet computers, laptop computers, and other internet-capable devices. Such a capability can allow the system to offload some processing duties to such devices.

The computing device may optionally include a mass storage device 315 such as a disk drive, CD-ROM drive, tape drive, flash memory, or the like, and the mass storage device may store programs and/or data. The system may also include a user interface 316 to facilitate interaction between the system and a user. The user interface may include a display device such as monitor, television screen, speakers, headphones or other devices that communicate information to the user. The display device may include visual, audio, or haptic display or some combination thereof.

In some implementations the system may include another input device 319 such as a pressure sensor, as discussed above. Alternatively, the input device 319 may include an accelerometer that provides information regarding acceleration with respect to one or more axes. Furthermore, the input device 319 may be configured to provide user input to the processor 302 in the manner of a mouse, keyboard, game controller, joystick, etc. may communicate with an I/O interface and provide control of the system to a user. Signals from the input device 319 may be interpreted by the other input processing 309 and the resulting information incorporated into the hazard detection and warning trigger routine 310.

The I/O 307 may implement wired or wireless communication among the sensor 321 processor 302 and warning device 323. By way of example, and not by way of limitation, the I/O 307 may implement wireless communication via radiofrequency signals according to one or more wireless protocols for example and without limitation Bluetooth, 802.11a, b, g, N, etc.

Example of Pedestrian Warning System Incorporated into Footwear

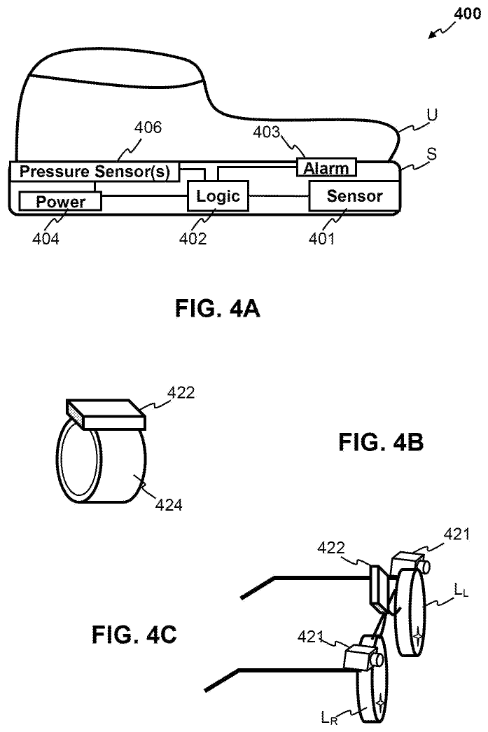

By way of example, and not by way of limitation, consider again the example, of a trip hazard warning system in which detectors and (optionally) probe signal sources are worn on the feet and configured to detect hazards that would cause the wearer to trip. FIG. 4A depicts an example of such an implementation.

As shown in FIG. 4A, an article of footwear may include a sole S attached to an upper U. The sole S may be made of any suitable material common for footwear, such as leather or rubber. Likewise, the upper may be made of suitable materials such as leather, canvas, cloth, rubber, or plastic. In the illustrated example, certain pedestrian hazard warning system components are incorporated into the sole S. However, aspects of the present disclosure are not limited to such implementations.

In FIG. 4A, a sensor 401, hazard determination logic element 402, and warning mechanism 403 are incorporated into the sole S. These components may be configured as discussed above with respect to FIG. 1, FIG. 2, or FIG. 3. In some implementations, two or all three components may be incorporated into a single device having, e.g., a common circuit board. Alternatively, the three components may be separate but operably coupled to each other, e.g., by signal conductors, such as insulated and shielded cables. Although FIG. 4A depicts system components incorporated into a single article of footwear, such components may be incorporated into two or more such articles, which may be worn on different feet or on the same foot.

A significant consideration for a system like that shown in FIG. 4A is the placement of the sensor 401. Generally, it is desirable to place the sensor in the forward part of the sole or upper to facilitate detection of hazards ahead. When incorporated into the sole S, the sensor 401 may require a sturdy housing that protects the sensor against damage and obstruction. In some implementations, it may be desirable to place the sensor 401 on the upper U, e.g., on a strap, buckle, or decorative element. Such placement keeps the sensor a little further from the ground and less susceptible to damage or obstruction.

There are other ways of incorporating the system components into footwear. For example, as shown in FIG. 4B, at least some of the system components may be incorporated into a housing 422 on a band 424 that can be worn on a pedestrian's toe. The band 424 may be made of elastic, rubber, metal, leather, or any other suitable material. In some implementations, the band may include a buckle, clasp, Velcro, snap or other mechanism to facilitate installation and removal of the ring and to provide adjustment to accommodate different sizes of toe. An advantage of such an implementation is that it can be easily used when a pedestrian wears open footwear such as sandals or flip-flops or is barefoot. Furthermore, although possible, not all system components need to be incorporated into the housing 422. For example, the sensor 401 and warning mechanism 403 may be incorporated into the housing while the logic element 402 is incorporated elsewhere. Alternatively, the warning mechanism 403 may be incorporated into the housing while the sensor 401 and logic element 402 are incorporated elsewhere. Components located outside the housing may communicate with those located within it through a wireless protocol, such as Bluetooth.

Aspects of the present disclosure are not limited to implementations involving footwear. For example, FIG. 4C illustrates an article of eyewear in which certain system components, e.g., the logic element 402 are incorporated into a housing mounted to a frame F. In the illustrated example, sensors 421_{L} and 421_{R} are located outside the housing proximate a left lens L_{L} and a right lens L_{R}, respectively. The warning mechanism 403 may be incorporated elsewhere, e.g., in an article of footwear. Alternatively, warning mechanisms may be incorporated into each of the lenses L_{L}, L_{R}. For example, light emitting diodes could flash to illuminate lower portions of the lenses when the logic element detects a hazard in the signal patterns from the sensors 421. The intensity and duration of the flash illumination may be configured to draw the wearer's gaze downwards in the general direction of a hazard.

The systems shown in FIGS. 4A-4C may optionally include a power source 404, such as a battery, solar cell, or capacitor that provides electrical power for operation of the sensor 401, hazard determination logic element 402, and warning mechanism 403. In the example shown in FIG. 4A, the power source may be incorporated into the sole S or the upper U. In the example shown in FIG. 4B the power source may be incorporated into the housing 422 or the band 424. In the example shown in FIG. 4C the power source may be incorporated into the housing 422, the frame F, or the lenses L_{L}, L_{R}.

In some implementations, the power source 404 may include a mechanism that generates electric power from a pedestrian's own motion. For example, a piezoelectric element coupled to a suitably configured rectification and energy storage circuit may be incorporated into the sole S. As the pedestrian walks, an increase pressure on the piezoelectric element induces a voltage, which can drive a current to a storage device such as a rechargeable battery or capacitor. A rectification element, e.g., a diode or diode bridge may be coupled between the storage device and the piezoelectric element to prevent a reverse of current when the pressure decreases.

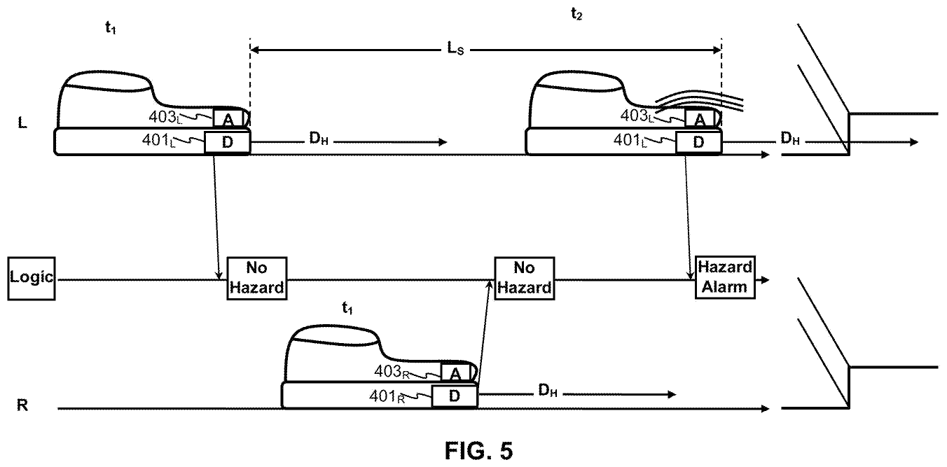

By way of example, as shown in FIG. 5, warning mechanisms 403 may be worn on each foot. In such an implementation, it is desirable for the warning draw the wearer's attention to the foot that is most likely to be tripped. For example, during normal walking the right foot R is in contact with the ground as the left foot L moves forward. When the left foot makes contact with the ground the right heel lifts and soon begins to move forward. If hazard detection logic detects a trip hazard from the left foot sensor signal it may be advantageous to trigger a warning from the right foot warning mechanism before the right foot has moved too much. (Situation 1) Alternatively, the hazard may be directly in front of the left foot while there is no hazard in front of the right foot. In such a situation it may be desirable to warn the left foot. (Situation 2) In both Situation 1 and Situation 2 it is desirable for the warning is delivered quickly enough that there is sufficient time for the wearer to react and avoid the hazard.

In the example illustrated in FIG. 5, the signal patterns provided by the sensors 401_{L}, 401_{R} on the left and right feet allow the logic 402 to determine hazards within a distance D_{H}. At time step t₁ both feet are at a distance greater than D_{H} from a hazard in the form of a step or curb so the logic does not trigger a hazard warning in either warning mechanism. At time step t₂, however, the left foot L is within the distance D_{H} of the hazard and the logic triggers a warning by the left foot warning mechanism 403_{L}.

For the implementation shown in FIG. 5 it is useful to take certain timing considerations into account. These include the following:

Duration of Stride—T_{S}; this is the time it takes the foot to move between instances of contact with the ground during a stride. Variable with pace.

Period of foot contact with ground—t_{g}; this is the time between when a foot first makes contact with the ground at the end of a stride and when it breaks contact with the ground to begin the next stride. When walking normally, the foot is approximately stationary during t_{g}.

Length of Stride—Lₛ; this is the distance the foot moves between instances of contact with the ground. Variable with gait

Hazard Detection Distance D_{H}; this is the distance within which the system can detect a hazard. D_{H} depends on the type of system.

Hazard Detection Time—t_{D}. This is the time that it takes the hazard detection logic to analyze the detector signal and detect a hazard.

Wearer Reaction Time—tᵣ. This is the time between when the wearer senses something and when the wearer reacts to it. This is typically about 250 milliseconds for visual sensation, but may vary for hearing, smell, touch, and taste.

Advance Warning time—T_{W}=T_{S}−t_{D}. This is the time between contact of a foot with the ground and the beginning of the warning.

Certain assumptions or approximations may be made to simplify analysis.

t_{g}≈Tₛ.

t_{g}>tᵣ

An implementation such as that shown in FIG. 5 desirably has certain system characteristics:

D_{H}>L_{S}

t_{D}<tᵣ

T_{W}>tᵣ

If T_{W}=T_{S}−t_{D} and we want T_{w}>tᵣ then Tₛ−t_{D}>t_{R} then, solving for t_{D} we have T_{S}−tᵣ>t_{D} or equivalently:

t_{D}<T_{S}−tᵣ.

As a numerical example, if T_{S}=650 ms and tᵣ is 250 ms then t_{D}<400 ms.

In some implementations, the sensor 101 and logic 102 in a pedestrian hazard warning system of the type described herein may be configured to recognize aids to hazard detection that are placed proximate to known hazards. For example, it is common for a step or curb to be marked with red or yellow paint, sometimes with warning indicia such as the word “step” or “hazard” or “caution”. Pedestrian hazard warning systems may be configured to recognize such markings. For example, if the sensor 101 is an optical sensor, such a sensor may be configured to be particularly sensitive to colors associated with hazards, e.g., red or yellow. Furthermore, if the sensor 101 is an optical imaging type sensor, the logic element 102 may include optical character recognition (OCR) software to identify text of potential warning indicia and some form of text recognition software, e.g., a look-up table, to associate identified text with known warning. The logic may also include image recognition software to identify known warning symbols, e.g., international symbols associated with tripping hazards and slipping hazards.

In some implementations, a pedestrian hazard warning system in accordance with aspects of the present disclosure may interact with aids to hazard detection that are configured to be readily detected by the sensor 101 and identified by the logic 102. By way of example, and not by way of limitation, such aids may include appropriately-configured indicia, e.g., a coded pattern that can be placed proximate a hazard. For example, the sensor may include an optical image detector 101 and the logic 102 may include a bar code reader or QR code reader. A known hazard may be marked with a bar code or QR code associated with the hazard that can be readily sensed with the sensor 101 and identified by the logic 102.

By way of non-limiting alternative example, aids to hazard detection may include active beacons that can be placed proximate a hazard emit a signal and emit a signal that can be readily sensed with the sensor 101 and identified by the logic 102. The following are non-limiting examples of suitable beacons for different types of sensors:
If the sensor 101 is an optical sensor, e.g., a photodiode, photoresistor, charge-coupled device (CCD) or array of such devices, the beacon may emit a corresponding optical signal, e.g., infrared (IR), visible, or ultraviolet (UV) radiation, from a suitable source such as a light emitting diode or laser diode.
If the sensor 101 is an electromagnetic sensor, e.g., a suitably configured antenna and detection electronics, the beacon may emit an electromagnetic signal, e.g., radiofrequency, microwave or terahertz radiation from a suitable source, such as a patch RFID emitter (radiofrequency) or Gunn diode (microwave radiation) or photoconductive terahertz emitter (terahertz radiation).
If the sensor 101 is an acoustic sensor, e.g., a microphone or other transducer such as a PMUT or CMUT, the beacon may emit an acoustic signal, e.g., ultrasound of frequency 20 kilohertz to several gigahertz from a suitable source, e.g., a PMUT or CMUT.

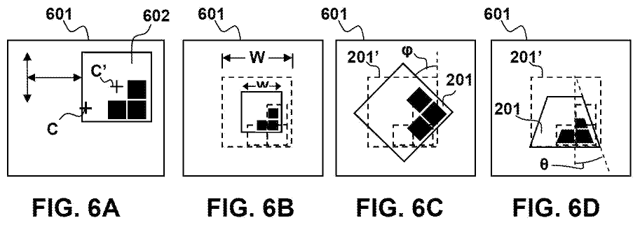

By way of example, and not by way of limitation, the sensor 101 may include an image sensor and the hazard determination logic 102 may be configured to determine the position of the image sensor by comparing an image 601 to reference data representing a known pattern 602. There are a number of ways of determining the position of the camera from the image from reference data. For example, a center C of the image can be associated with a projection of the position of the camera in three dimensions onto the plane of the pattern 602. The instructions logic 102 can identify a portion of the pattern 602 closest to the center C of the image 103 as shown in FIG. 6A. The position of the cell closest to the image center C can provide a coarse position. The coarse position can be refined by determining the location of the image center C with respect to a center C′ of the portion of the pattern 602.

In such implementations, the hazard determination logic 102 may be configured to analyze the image 601 to determine a perpendicular distance D of the sensor 101 relative to the plane of the pattern 602. As used herein, the term “perpendicular distance” refers to a distance along an axis perpendicular to the plane of the pattern. By way of example, as shown in FIG. 6B, a characteristic size w′ of the portion of pattern 602 within the image 601 can be compared to a known reference size W of the pattern 602. The reference size W can be determined in a calibration phase when the sensor 101 is at a known perpendicular distance D_{ref} from the pattern 602. Alternatively, information regarding the reference size W may be encoded into the pattern 602 itself, e.g., as a QR code. The perpendicular distance D can be determined from the known perpendicular distance D_{ref} and the ratio W/w.

D=D_{ref}(W/w).

The logic 102 can also be configured to determine an angular orientation of the sensor 101 with respect to the pattern 602 as illustrated in FIG. 6C and FIG. 6D. For example, the pattern 602 can be chosen so that it is not rotationally symmetric with respect to an axis normal to the plane of the surface. If the pattern is not rotationally symmetric, the logic 102 can determine a rotational orientation angle φ of the sensor 101 with respect to the axis normal to the plane of the pattern by comparing the orientation of the pattern 602 in the image 601 to the orientation of a reference pattern 602′ as shown in FIG. 6C.

Alternatively, the logic 102 may also be configured to analyze a distortion of the pattern 602 in the image 601 to determine a pitch or roll of the sensor 101 relative to the pattern 602. For example, as shown in FIG. 6D, the instructions can analyze an angle of convergence angle θ for grid lines within the pattern 602 in the image 601. The angle of convergence θ can be related to an angle of pitch of the camera relative to the pattern 602.

As noted above, aspects of the present disclosure encompass devices worn on parts of the body other than the foot to warn of potential hazards. Examples include, but are not limited to:

1) devices worn on the head to warn of obstructions at head height;

2) devices worn on an arm, elbow, wrist, or hand to warn of obstructions thereto;

3) devices worn on the a shin, knee, or thigh to warn of obstructions thereto.

Aspects of the present disclosure provide a pedestrian hazard warning system that enhances pedestrian safety under a variety of conditions.

In the interest of clarity, not all of the routine features of the implementations described herein are shown and described. It will be understood by those skilled in the art that in the development of any such implementations, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of the present disclosure.

In accordance with aspects of the present disclosure, the components, process steps, and/or data structures may be implemented using various types of operating systems; computing platforms; user interfaces/displays, including personal or laptop computers, video game consoles, PDAs and other handheld devices, such as cellular telephones, tablet computers, portable gaming devices; and/or general purpose machines. In addition, those of ordinary skill in the art will recognize that devices of a less general purpose nature, such as hardwired devices, field programmable gate arrays (FPGs), application specific integrated circuits (ASICs), or the like, may also be used without departing from the scope and spirit of the inventive concepts disclosed herein.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC § 112(f).

What is claimed is:

1. A pedestrian hazard warning system, comprising:
a sensor device configured to sense a signal reflected from objects at ground-level and generate a corresponding output;
hazard determination logic configured to analyze the output from the sensor device and determine therefrom an abrupt change in ground-level conditions that corresponds to the presence of a hazard; and
a wearable warning mechanism interoperable with the hazard determination logic and configured to trigger in a pedestrian an instinctive response that draws the pedestrian's attention towards the hazard.

2. The system of claim 1, wherein the sensor includes a passive component that receives a probe signal reflected from or emitted by ground-level objects in the pedestrian's environment.

3. The system of claim 2, wherein the passive element is configured to sense an optical probe signal, an electromagnetic probe signal, or an acoustic probe signal.

4. The system of claim 2, wherein the probe signal is supplied by an environment.

5. The system of claim 2, wherein the sensor further includes a probe signal source that projects the probe signal.

6. The system of claim 5, wherein the probe signal source is configured to project the probe signal generally forward of a pedestrian.

7. The system of claim 5, wherein the probe signal source and a reflected signal detector of the sensor are located close to each other and in more or less fixed positions and orientations with respect to each other.

8. The system of claim 7, wherein the source and reflected signal detector are part of a common integrated circuit chip.

9. The system of claim 7, wherein the sensor includes two or more different types of detection device, wherein each of the two or more different types of detection device is optimized for detecting hazards at different distances.

10. The system of claim 14, wherein the two or more different types of detection device include an acoustic detection device and an optical detection device.

11. The system of claim 1, wherein the warning mechanism is configured to produce an audible, visible, tactile or olfactory signal.

12. The system of claim 1, wherein the warning mechanism includes a vibrating element.

13. The system of claim 1, wherein the warning mechanism is configured to optically illuminate a hazard.

14. The system of claim 1, wherein the warning mechanism is incorporated into an article of clothing.

15. The system of claim 1, wherein the article of clothing is a shoe, boot, slipper, sandal, sock or stocking, glove, legging, pant leg, ring, buckle, pair of eyeglasses, hat, or bracelet.

16. The system of claim 1, wherein the sensor and hazard determination logic are configured to recognize aids to hazard detection that are placed proximate to known hazards.

17. The system of claim 30, wherein the sensor is an optical sensor configured to be particularly sensitive to colors associated with hazards.

18.The system of claim 30, wherein the sensor is an image sensor and the logic element is configured to identify text of potential warning indicia in an image and associate identified text with a known warning.

19. The system of claim 30, wherein the sensor is an image sensor and the logic element is configured to analyze one or more images obtained with the sensor and identify warning symbols associated with hazards in the one or more images.

20. A method for warning a pedestrian of hazards, comprising:
sensing a signal reflected from objects at ground-level with a sensor and generating a corresponding output;
analyzing the output from the sensor device with hazard determination logic and determine therefrom an abrupt change in ground-level conditions that corresponds to the presence of a hazard; and
thereafter causing a wearable warning mechanism to trigger in a pedestrian an instinctive response that draws the pedestrian's attention towards the hazard.
